(19) United States
(12) Patent Application Publication
(10) Pub. No.: US 2026/0085996 A1
(43) Pub. Date: Mar. 26, 2026

(54) OPTICAL COMPONENT, OPTICAL CHIP, AND FAULT DETECTION APPARATUS

(71) Applicant: SILITH TECHNOLOGY (SHANGHAI) CO., LTD., Shanghai (CN)

(72) Inventors: Yuxuan CHEN, Shanghai (CN); Ke ZHANG, Shanghai (CN); Yunchu YU, Shanghai (CN); Guangzhu ZHOU, Shanghai (CN); Zhexuan ZHENG, Shanghai (CN)

(73) Assignee: SILITH TECHNOLOGY (SHANGHAI) CO., LTD., Shanghai (CN)

(21) Appl. No.: 19/030,515

(22) Filed: Jan. 17, 2025

(30) Foreign Application Priority Data
Sep. 24, 2024 (CN) 202411328303.6

(51) Int. Cl. G01M 11/00; G02B 6/10

(52) U.S. Cl. CPC G01M 11/30; G02B 6/102

(57) ABSTRACT

The present disclosure arranges a first waveguide and a plurality of second waveguides on a substrate; the plurality of second waveguides are arranged distributing around the first waveguide, and having an interval from the first waveguide; the first waveguide is configured to conduct invisible light; the plurality of second waveguides are configured to conduct visible light, while the visible light is configured to position a failure point. By arranging the plurality of second waveguides to conduct the visible light, so as to determine the failure point, it is able to not only position a chip defect accurately, but also achieve a failure positioning without using a destructive method, thus it is able to shorten a chip iteration period effectively, further reducing a product cost.

### CROSS-REFERENCE TO RELATED APPLICATION

This application claims the priority benefit of China application serial no. 202411328303.6, filed on Sep. 24, 2024. The entirety of the above-mentioned patent application is hereby incorporated by reference herein and made a part of this specification.

### BACKGROUND

### Technical Field

The present disclosure relates to the technical field of communications, in particular to an optical component, an optical assembly, an optical chip, a communication device, a detection apparatus and a fault detection apparatus.

### Description of Related Art

At present, an optical chip has a long tapeout period, and a high tapeout cost, thus a failure analysis to the optical chip is crucial in a process optimization and a yield improvement for a product of the optical chip. A plurality of common faults causing the optical chip failing include a defect embedded in a process (such as a structural dimension failed to meet a design requirement, a material strength failed to reach a demand value) and a defect happened during an operation flow (such as an electrostatic environment or a stress condition in an environment for production and transportation not reaching a standard), and more. Since a design of the optical chip has a complexity and a high integration, and a working waveband of the optical chip is usually locating in a non-visible light spectrum, when a failure occurs, it lacks an intuitive and effective method to position a defect. In addition, in the prior art, positioning a failure usually relies only on a destructive wafer-cutting mode, to observe a plurality of cross-sectional views of a plurality of suspected defect occurring points, so as to perform the failure analysis. However, using a plurality of slices to carry out a defect analysis is ruining a whole chip/wafer totally, while having a low accuracy. If a slice is taken from a section in front of or behind the failure, a wrong judgment may be concluded that the section has no defect.

Therefore, it is urgently needed for an optical assembly, an optical chip, a communication device and a detection apparatus to improve the problems stated above.

### SUMMARY

An objective of the present disclosure is providing an optical assembly, an optical chip, a communication device and a detection apparatus, being able to provide an intuitive on-chip optical path monitoring method, without affecting a performance of the chip, so as to position a defect of the chip accurately.

According to a first aspect, the present disclosure provides an optical component, comprising: a substrate, a first waveguide and a plurality of second waveguides arranged on the substrate;
the plurality of second waveguides are arranged around the first waveguide, and having an interval from the first waveguide;
the first waveguide is configured to conduct invisible light;
the plurality of second waveguides are configured to conduct visible light, and the visible light is configured to position a failure point.

The present disclosure has the following beneficial effects: the present disclosure arranges the first waveguide and the plurality of second waveguides on the substrate; and arranges the plurality of second waveguides distributing around the first waveguide, while having an interval from the first waveguide. The first waveguide is configured to conduct invisible light; and the plurality of second waveguides are configured to conduct visible light, while the visible light is configured to position a failure point. By arranging the plurality of second waveguides to conduct the visible light, so as to determine the failure point, it is able to position a chip defect accurately, and achieve a failure positioning without using a destructive method, thus it is able to shorten a chip iteration period effectively, therefore lowering a product cost.

Preferably, the plurality of second waveguides have an amount of N, wherein N is a positive integer;
N number of second waveguides are arranged distributing around the first waveguide. A beneficial effect is, by arranging the N number of second waveguides around the first waveguide, it is able to better position the failure points all around the first waveguide.

Preferably, when N equals to 2, each of two opposite sides of the first waveguide has one of the plurality of second waveguides arranged respectively.

Preferably, a bottom surface of each of the plurality of second waveguides and the first waveguide are on a same horizontal plane;
a height of any one of the plurality of second waveguides is less than a height of the first waveguide; and/or a width of any one of the plurality of second waveguides is less than a width of the first waveguide. A beneficial effect is: by arranging the bottom surface of any one of the plurality of second waveguides and the first waveguide on the same horizontal plane, and arranging the height of any one of the plurality of second waveguides less than the height of the first waveguide; and/or the width of any one of the plurality of second waveguides less than the width of the first waveguide, it is able to facilitate to position the failure point, while reducing an influence on the first waveguide, and ensuing a chip performance.

Preferably, a wavelength of the visible light conducted by the plurality of second waveguides is 400-780 nanometers. By arranging the wavelength of the visible light conducted by the plurality of second waveguides to be 400-780 nanometers, it is able to have a better response to a process defect or a stress fault, thus facilitating to position the failure point quickly and accurately, and greatly facilitating a failure defect analysis.

Preferably, an interval between the plurality of second waveguides and the first waveguide is 4-8 microns. By arranging the interval between the plurality of second waveguides and the first waveguide to be 4-8 microns, it is able to keep a safe distance between the plurality of second waveguides and the first waveguide, and an optical mode thereof will not affect each other, thus it is able to avoid the optical mode from deviating to the first waveguide, while reflecting a morphology of the first waveguide effectively, thus ensuring an overall performance.

Preferably, the first waveguide is a silicon nitride waveguide; and/or the plurality of second waveguides are a plurality of silicon nitride waveguides. A beneficial effect is, by arranging the first waveguide and/or the plurality of second waveguides being made of the silicon nitride, it is able to improve the chip performance.

Preferably, a silicon dioxide layer is arranged on the substrate;
the first waveguide and the plurality of second waveguides are all arranged inside the silicon dioxide layer. A beneficial effect is, by arranging the silicon dioxide layer on the substrate, and arranging all of the first waveguide and the plurality of second waveguides inside the silicon dioxide layer, it is able to improve the performance and stability of the chip.

According to a second aspect, the present disclosure further provides an optical chip, comprising an optical component in any one possible combination in the first aspect.

According to a third aspect, the present disclosure further provides a communication device, comprising the optical chip in the second aspect.

According to a fourth aspect, the present disclosure further provides a fault detection apparatus, comprising the communication device in the third aspect, a detection sensor, and a marking module;
the detection sensor is arranged in the communication device, and electrically connected with the marking module;
the detection sensor is configured to detect a failure point on a surface of the communication device; and
the marking module is configured to mark out the failure point.

A plurality of beneficial effects from the second aspect to the fourth aspect, may be referred to the descriptions in the first aspect.

### BRIEF DESCRIPTION OF THE DRAWINGS

FIG. 1 illustrates a schematic structural diagram on an optical assembly according to an embodiment of the present disclosure;

FIG. 2 illustrates a schematic diagram on an optical mode of light with a wavelength of 450 nm in any one of a plurality of second waveguides according to an embodiment of the present disclosure;

FIG. 3 illustrates a schematic diagram on an optical mode of light with a wavelength of 1550 nm in a main waveguide made of silicon nitride according to an embodiment of the present disclosure;

FIG. 4 illustrates a schematic structural diagram on a detection apparatus according to an embodiment of the present disclosure.

### DESCRIPTION OF THE EMBODIMENTS

To make the objective, technical solutions and advantages of the present invention clearer, the technical solutions in the embodiments of the present invention will be clearly and completely described below with reference to the accompanying drawings of the present invention. Apparently, the embodiments described are some rather than all of the embodiments of the present invention. All other embodiments obtained by those of ordinary skill in the art based on the embodiments of the present invention without creative efforts shall fall within the scope of protection of the present invention. The technical or scientific terms used herein shall have the usual meanings understood by those of ordinary skill in the art to which the present invention belongs, unless otherwise defined. The similar term such as “include or comprise” refers to that an element or item that appears before the term covers elements or items listed after the term and their equivalents, without excluding other elements or items.

In view of an inconvenience of positioning a failure in an optical chip, the optical chip provided by the present disclosure is able to position a chip defect accurately, and achieve a failure-positioning without using a destructive method, so that a chip iteration period can be effectively shortened, thereby lowering a product cost. The technical solutions in the embodiments of the present disclosure are further described hereafter, with reference to the accompanying drawings in the embodiments of the present disclosure. In the description of the embodiments of the present disclosure, the terms used in the following embodiments are only for the purpose of describing particular embodiments, instead of limiting the present disclosure. As used in the specification and the appended claims of the present disclosure, the singular expressions “a”, “the” are intended to include such expressions, for example, “one or more”, unless the context clearly indicates an opposite arrangement. It should also be understood that, in the following embodiments of the present disclosure, “at least one” and “one or more” refer to one or more than two (including two). The term “and/or” is used to describe an association relationship between associated objects, indicating that there may be three relationships; for example, A and/or B may indicate that A exists alone, both A and B exist, and B exists alone, wherein, both A and B may be singular or plural. The character “/” generally indicates an “or” relationship between the associated objects.

Reference to “one embodiment” or “some embodiments” in the present specification means that a particular feature, structure, or characteristic described in connection with the embodiment is included in one or more embodiments of the invention. Thus, the appearances of the phrases “in one embodiment”, “in some embodiments”, “in some other embodiments”, “in some other embodiments”, “in some embodiments”, “in some other embodiments”, “in some other embodiments”, “in some embodiments”, “in some other embodiments”, “in some other embodiments” do not necessarily refer to the same embodiment, but mean “one or more but not all embodiments” unless otherwise specifically emphasized. The terms “comprising,” “including,” “having,” and variations thereof mean “including, but not limited to,” unless otherwise specifically emphasized in other ways. The term “connected” includes both direct and indirect connections, unless stated otherwise. The terms “first” and “second” are used for descriptive purposes only and cannot be understood as indicating or implying relative importance or implicitly indicating the number of indicated technical features.

In the embodiments of the present disclosure, “exemplarily” or “for example” is used to represent giving an example, an illustration, or a description. Any embodiment or design scheme described as “example” or “for example” in the embodiments of the present disclosure should not be explained as being more preferred or having more advantages than another embodiment or design scheme. Exactly, use of “example” or “for example” is intended to present a related concept in a specific manner.

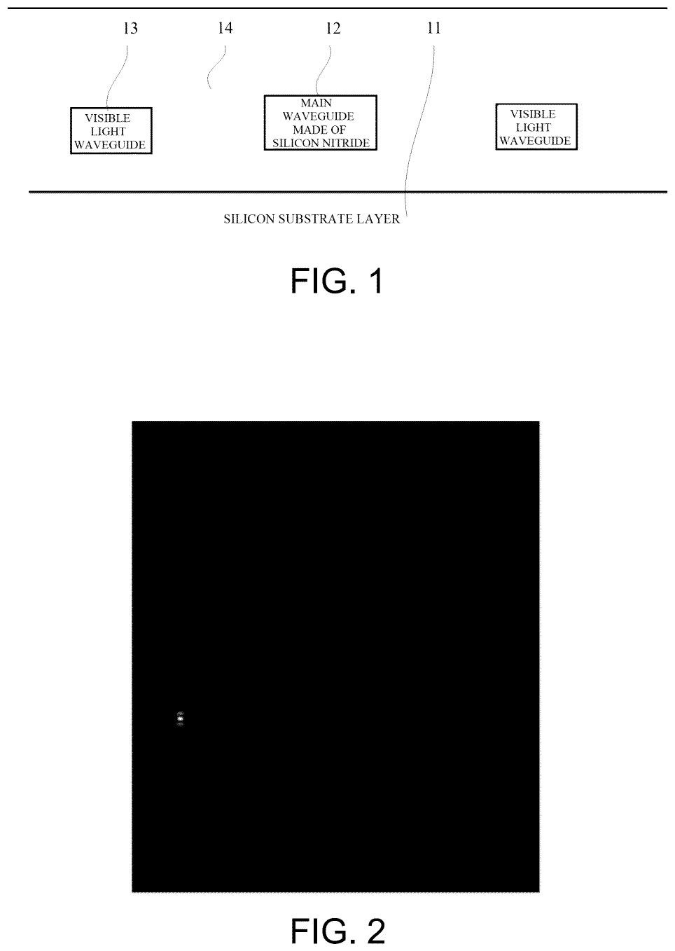

Shown as FIG. 1, the present disclosure provides an optical assembly, comprising: a substrate (such as a silicon substrate layer 11), a first waveguide (such as a main waveguide made of silicon nitride 12) and a plurality of second waveguides (such as a plurality of visible light waveguides 13) arranged on the substrate; the plurality of second waveguides are arranged around the first waveguide, and having an interval from the first waveguide; the first waveguide is configured to conduct invisible light; the plurality of second waveguides are configured to conduct visible light, while the visible light is configured to position a failure point. Determining the failure point by adding the plurality of second waveguides configured to conduct the visible light, if a failure is induced by a size of a waveguide in a communication band being too small due to a process defect, then a size of a visible light waveguide will be smaller for sure, and causing the failure; or if the waveguide in the communication band is broken or misaligned due to a stress defect, then the visible light waveguide will also be broken or misaligned in a length, and a visible light will be emitted from the visible light waveguide before being caught by an eye or a detecting sensor, thus a chip defect can be accurately positioned, and the failure point can be positioned quickly and accurately, so as to facilitate a failure defect analysis greatly. Comparing with a failure positioning method in the prior art that relies only on a destructive wafer cutting method, and carries out a failure analysis by observing a plurality of cross-sectional views comprising a plurality of suspected defect occurrence points, since a destructive method is not required to achieve the failure positioning, it is able to shorten a chip iteration period effectively, and reduce a product cost. It should be noted that, a failure threshold of anyone of the plurality of second waveguides is lower than a failure threshold of the first waveguide, when a waveguide is broken or misaligned due to a process defect or a stress defect, it is the plurality of second waveguides instead of the first waveguide being easier to get broken, thus visible light transmission in one of the plurality of second waveguides is directly interrupted or obviously weakened from a breakpoint, making it impossible to monitor the visible light in the waveguide starting from the breakpoint, thereby a failure point is positioned. It should be understood that when the visible light is able to complete a transmission in the plurality of second waveguides, it indicates that there is no failure point; and when an optical path is interrupted in a middle of one of the plurality of second waveguides, it indicates that a breakpoint (ie, a fracture point) is the failure point. In addition, an optical path is different to an electric circuit, even if an optical path is broken, a light can still be transmitted in a waveguide.

In a plurality of embodiments, in order to better position all of the failure points around the first waveguide, an amount of the plurality of second waveguides is N, wherein N is a positive integer; N number of the second waveguides are arranged distributing around the first waveguide. It is noted that, when the plurality of second waveguides are arranged distributing around the first waveguide, as long as they are not effecting a light transmission in the first waveguide, a position of the plurality of second waveguides may be arranged flexibly and an amount thereof may be increased or decreased according to a requirement.

In a plurality of specific embodiments, shown as FIG. 1, when N equals to 2, it is preferable that each of two opposite sides of the first waveguide has one second waveguide arranged respectively, while two second waveguides may be arranged symmetrically, or may be adjusted according to an actual requirement.

In a plurality of specific embodiments, in order to facilitate positioning the failure point, and reducing an influence to the first waveguide, while ensuring a chip performance, a bottom surface of each of the plurality of second waveguides is on a same horizontal plane with the first waveguide, a height of any one of the plurality of second waveguides is less than a height of the first waveguide, and/or a width of any one of the plurality of second waveguides is less than a width of the first waveguide.

In a plurality of embodiments, in order to better respond to a process defect or a stress fault, so as to facilitate positioning a failure point quickly and accurately, and greatly facilitate analyzing a failure defect, a wavelength of the visible light conducted by the plurality of second waveguides is 400-780 nanometers (endpoint values are included).

In an embodiment, a wavelength of the visible light conducted by the plurality of second waveguides is 450 nm, which is much less than a common wavelength in a communication application (such as 1310 nm or 1550 nm, which is a wavelength of the invisible light conducted by the first waveguide). Thus, a waveguide configured to conduct the visible light has a smaller size, being able to better respond to the process defect or the stress fault.

In a plurality of embodiments, in order to keep a safe interval between the first waveguide and the plurality of second waveguides, so an optical mode thereof will not affect each other, thus preventing the optical mode from deviating to the first waveguide, while being able to reflect a morphology of the first waveguide effectively, and ensure an overall performance, the interval between the plurality of second waveguides and the first waveguide is 4-8 microns (endpoint values are included). In an embodiment, the first waveguide and the plurality of second waveguides are keeping in a safe interval (such as 6 microns), so as to prevent the optical mode from deviating to the first waveguide, while reflecting the morphology of the first waveguide effectively. It is noted that, arranging the interval requires to refer to a width of the first waveguide. In an embodiment, when the width of the first waveguide is relatively large, the interval needs to be enlarged, and when the width is relatively narrow, it is possible to reduce the interval according to an actual need, as long as ensuring that a presence of the plurality of second waveguides does not affect the light transmission in the first waveguide.

In a plurality of embodiments, in order to improve the chip performance, the first waveguide is a silicon nitride waveguide; and/or the plurality of second waveguides are the silicon nitride waveguide.

In a plurality of embodiments, in order to improve a performance and stability of the chip, shown as FIG. 1, a silicon dioxide layer 14 is arranged on the substrate, while all the first waveguide and the plurality of second waveguides are arranged inside the silicon dioxide layer 14.

Based on the optical assembly stated above, shown as FIG. 1, the present disclosure further provides an optical chip, comprising the optical assembly stated above.

For an easier understanding, a specific implementation process of the optical chip is further described herein, in combination with a specific application scenario, comprising following steps specifically:

arranging the plurality of second waveguides on both sides of the waveguide of the optical chip respectively, configured to conduct the visible light (ie, the plurality of visible light waveguides 13). A wavelength of the visible light (eg, 450 nm) is much less than a common wavelength in a communication application (eg, 1310 nm and 1550 nm). Thus, the waveguide configured to conduct the visible light has a smaller size, which is able to respond to the process defect or the stress fault better. Specifically, if a size of a waveguide in the communication band is too small and causing a failure due to a process defect, then a size of a visible light waveguide will be smaller for sure, and causing the visible light waveguide fail; or if the waveguide in the communication band is broken or misaligned due to a stress defect, then the visible light waveguide will also be broken or misaligned in a length.

On another aspect, since the size of the plurality of second waveguides is relatively small, neither affecting the optical mode in the communication band, nor causing additional loss or affecting an original optical chip performance. Meanwhile, a conduction state of the visible light waveguide can be visually observed through a naked eye, thus it is possible to position the failure point quickly and accurately, greatly facilitating the failure defect analysis, without generating any damage to the optical chip, or affecting any subsequent testing and data analysis for the optical chip.

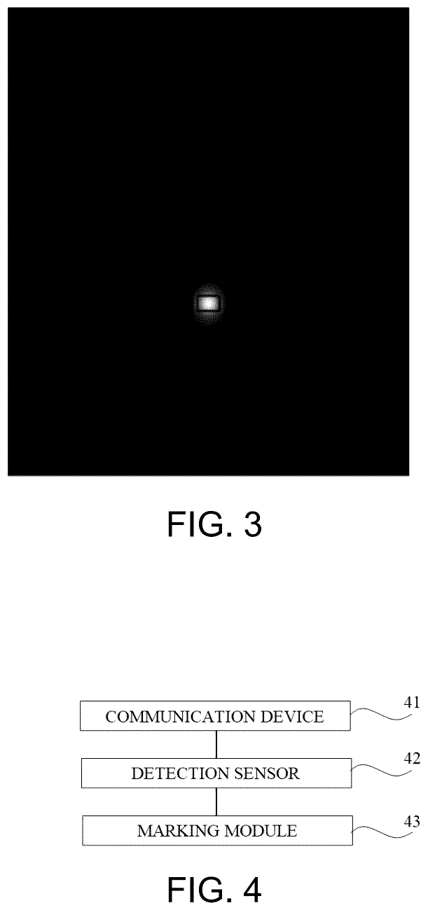

An embodiment is given below, in the embodiment, a waveguide material of the optical chip is silicon nitride, and a simplified cross-sectional view of the optical chip is shown as FIG. 1. On each of both sides of a main waveguide made of silicon nitride, there is a second waveguide arranged to conduct a visible light with a wavelength of 450 nm. A bottom of each of the visible light waveguides and the main waveguide made of silicon nitride are arranged on a same horizontal plane, while both the height and the width thereof are less than that of the main waveguide made of silicon nitride, and the interval between the main waveguide made of silicon nitride and the plurality of second waveguides is sufficient, thus the optical modes in the first waveguide and the plurality of second waveguides will not affect each other. A feasibility of the present solution has been well proved by an optical mode field distribution calculated by a simulation software FDTD (Finite-Difference Time-Domain). As shown in FIG. 2, a light with a wavelength of 450 nm is well bound in the plurality of second waveguides, while keeping a safe distance (6 microns) away from the first waveguide, so that the optical mode thereof is prevented from deviating to the first waveguide, while the morphology of the first waveguide has been effectively reflected. On another aspect, shown as FIG. 3, an optical mode of a light with a wavelength of 1550 nm is not affected by the plurality of second waveguides at all, thereby an overall performance of the optical chip has been ensured.

The present embodiment has an advantage that, a fault is positioned accurately, an on-off of the visible light waveguide will reflect a state of the main waveguide, a fault diagnosis is highly efficient, while avoiding a repeated and multi-point slicing for a fault analysis, further the optical chip will not be damaged, and the optical chip to be tested is completely reserved.

It should be noted that, a key point of the present disclosure is an arrangement mode of the visible light waveguide, instead of limiting to a specific design of the visible light waveguide. The present disclosure has negligible impact on a cost and a performance of a functional chip itself, an on-chip process of the visible light waveguide is directly compatible with an existing optical chip process. Meanwhile, a visual characteristic of the visible light can well reflect an on-off and a trend of an on-chip optical path, that greatly helps analyzing and positioning a fault, thus makes up the defects in the prior art.

Based on the optical chip stated above, the present disclosure further provides a communication device, comprising the optical chip shown in FIG. 1.

Based on the communication device stated above, shown as FIG. 4, the present disclosure further provides a fault detection apparatus, comprising a communication device 41 as stated above, a detection sensor 42, and a marking module 43; the detection sensor 42 is arranged in the communication device 41, the detection sensor 42 and the marking module 43 are electrically connected; the detection sensor 42 is configured to detect the failure point on a surface of the communication device 41; and the marking module 43 is configured to mark out the failure point.

In addition, the suffixes such as “module”, “component” or “unit” used to represent elements are merely illustrative of the present disclosure, which itself is of no particular meaning. Thus, the “module”, “component”, or “unit” may be used in admixture.

It may be clearly understood by a person skilled in the art that, for the purpose of convenient and brief description, the foregoing functional units and division of the modules are used for illustration only, and in a practical application, the foregoing functions may be allocated to different functional units or modules to realize according to a requirement, that is, the internal structure of the apparatus is divided into different functional units or modules to complete all or some of the functions described above. Functional units and modules in the embodiments may be integrated into one processing unit, or each of the units may exist alone physically, or two or more units are integrated into one unit, and the integrated units may be implemented in a form of hardware, or may be implemented in a form of a software functional unit. In addition, the specific names of the functional units and modules are merely for ease of distinguishing from each other, and are not intended to limit the protection scope of the present disclosure.

All above, the optical assembly, the optical chip, the communication device and the detection apparatus disclosed in the present disclosure, by arranging the plurality of second waveguides to conduct the visible light, so as to determine the failure point, it is able to not only position a chip defect accurately, but also position a failure without using a destructive method, thus it is able to shorten a chip iteration period effectively, further reducing a product cost.

Although the embodiments of the present disclosure have been described in detail above, it is apparent to those skilled in the art that various modifications and variations can be made to these embodiments. However, it is to be understood that such modifications and variations are within the scope and spirit of the disclosure as described in the appended claims and embodiments. Furthermore, the present disclosure described herein may have other embodiments and may be carried out or implemented in various ways.

What is claimed is:

1. An optical component, comprising: a substrate, a first waveguide and a plurality of second waveguides arranged on the substrate;
wherein the plurality of second waveguides are arranged around the first waveguide, and having an interval from the first waveguide;
the first waveguide is configured to conduct invisible light;
the plurality of second waveguides are configured to conduct visible light, and the visible light is configured to position a failure point.

2. The optical component according to claim 1, wherein the plurality of second waveguides have an amount of N, wherein N is a positive integer;
N number of second waveguides are arranged distributing around the first waveguide.

3. The optical component according to claim 2, wherein when N equals to 2, each of two opposite sides of the first waveguide has one of the plurality of second waveguides arranged respectively.

4. The optical component according to claim 1, wherein a bottom surface of each of the plurality of second waveguides and the first waveguide are on a same horizontal plane;
a height of any one of the plurality of second waveguides is less than a height of the first waveguide; and/or a width of any one of the plurality of second waveguides is less than a width of the first waveguide.

5. The optical component according to claim 1, wherein a wavelength of the visible light conducted by the plurality of second waveguides is within a range of 400-780 nanometers.

6. The optical component according to claim 1, wherein an interval between the plurality of second waveguides and the first waveguide is within a range of 4-8 microns.

7. The optical component according to claim 1, wherein the first waveguide is a silicon nitride waveguide; and/or the plurality of second waveguides are a plurality of silicon nitride waveguides.

8. The optical component according to claim 1, wherein a silicon dioxide layer is arranged on the substrate;
the first waveguide and the plurality of second waveguides are all arranged inside the silicon dioxide layer.

9. The optical component according to claim 8, wherein the plurality of second waveguides have an amount of N, wherein N is a positive integer;
N number of second waveguides are arranged distributing around the first waveguide.

10. The optical component according to claim 8, wherein a bottom surface of each of the plurality of second waveguides and the first waveguide are on a same horizontal plane;
a height of any one of the plurality of second waveguides is less than a height of the first waveguide; and/or a width of any one of the plurality of second waveguides is less than a width of the first waveguide.

11. An optical chip, wherein comprising the optical component according to claim 1.

12. The optical chip according to claim 11, wherein the plurality of second waveguides have an amount of N, wherein N is a positive integer;
N number of second waveguides are arranged distributing around the first waveguide.

13. The optical chip according to claim 12, wherein when N equals to 2, each of two
opposite sides of the first waveguide has one of the plurality of second waveguides arranged respectively.

14. The optical chip according to claim 11, wherein a bottom surface of each of the plurality of second waveguides and the first waveguide are on a same horizontal plane;
a height of any one of the plurality of second waveguides is less than a height of the first waveguide; and/or a width of any one of the plurality of second waveguides is less than a width of the first waveguide.

15. The optical chip according to claim 11, wherein a wavelength of the visible light conducted by the plurality of second waveguides is within a range of 400-780 nanometers.

16. The optical chip according to claim 11, wherein an interval between the plurality of second waveguides and the first waveguide is within a range of 4-8 microns.

17. The optical chip according to claim 11, wherein the first waveguide is a silicon nitride waveguide; and/or the plurality of second waveguides are a plurality of silicon nitride waveguides.

18. The optical chip according to claim 11, wherein a silicon dioxide layer is arranged on the substrate;
the first waveguide and the plurality of second waveguides are all arranged inside the silicon dioxide layer.

19. A fault detection apparatus, comprising a communication device, a detection sensor, and a marking module; the communication device comprising the optical chip according to claim 11;
the detection sensor is arranged in the communication device, while the detection sensor and the marking module are electrically connected;
the detection sensor is configured to detect a failure point on a surface of the communication device; and
the marking module is configured to mark out the failure point.

20. The fault detection apparatus according to claim 19, wherein the plurality of second waveguides have an amount of N, wherein N is a positive integer;
N number of second waveguides are arranged distributing around the first waveguide.
